(19) United States
(12) Patent Application Publication
(10) Pub. No.: US 2019/0112196 A1
(43) Pub. Date: Apr. 18, 2019

(54) CATION-MODIFIED SILICA RAW MATERIAL DISPERSION

(71) Applicant: FUJIMI INCORPORATED, Aichi (JP)

(72) Inventors: YUKARI UEHARA, Aichi (JP); TAKEHIRO UMEDA, Aichi (JP); SHOGO ONISHI, Aichi (JP)

(21) Appl. No.: 16/089,933

(22) PCT Filed: Mar. 8, 2017
(86) PCT No.: PCT/JP2017/009312

§ 371 Date: Sep. 28, 2018

(30) Foreign Application Priority Data
Mar. 30, 2016 (JP) 2016-067149

(51) Int. Cl. C01B 33/148; C09G 1/02; C01B 33/149; C09K 3/14

(52) U.S. Cl. CPC C01B 33/1485; C09G 1/02; C01P 2004/51; C09K 3/14; C01B 33/149

(57) ABSTRACT

Intended is to provide a cation-modified silica dispersion wherein viscosity change with lapse of time is suppressed, and also intended is to suppress the variation in performance of a product using the dispersion as a raw material (for example, a polishing agent).

A cation-modified silica raw material dispersion which is being stored after being adjusted to less than pH 7.0.

### TECHNICAL FIELD

The present invention relates to a cation-modified silica raw material dispersion.

### BACKGROUND ART

In recent years, with the increase of integration and performance of large scale integration (LSI), new microprocessing techniques are being developed. The chemical mechanical polishing (CMP) method is one of such techniques, and frequently used in flattering of interlayer insulating films, metal plug formation, and buried wiring (damascene wiring) formation in LSI manufacturing process, especially multilayer wiring formation process.

In CMP, silica sol is preferred as a raw material of abrasive grains of a polishing agent.

However, silica sol has a problem of poor stability, because silica causes agglomeration under acidic conditions.

In order to solve this problem, there is a technique for cation-modifying silica (Patent Literature 1).

### CITATION LIST

### Patent Literature

Patent Literature 1: Japanese Unexamined Patent Application Publication No. 2005-162533

### SUMMARY OF INVENTION

### Technical Problem

The pH of the above-described silica sol obtained by cationic modification is adjusted to a weak alkaline region thereby preventing agglomeration of the silane coupling agent during modification, and the final pH is in the weak alkaline region. Commercial products are also adjusted in such region.

However, it was found that that if silica sol is stored under these conditions, the viscosity change occurs with the lapse of time. It was found that the performance of a product (for example, a polishing agent) varies when it includes silica sol as a raw material which has caused viscosity change.

Accordingly, the present invention is intended to provide a cation-modified silica dispersion which suppresses the viscosity change caused by the lapse of time, and also to suppress the variation in performance of a product using the dispersion as a raw material (for example, a polishing agent).

### Solution to Problem

The inventors carried out dedicated researches for finding the cause. During this process, they found that cation-modified silica stored in an alkali environment causes the viscosity change of silica sol. Then, they considered that a storage period of the cation-modified silica sol give rise to a difference of viscosity change, and the result influences the polishing properties. They also found that the influence of the polishing properties cannot be avoided even if the viscosity of the polishing agent is finally adjusted with a viscosity adjusting agent.

Accordingly, the inventors carried out dedicated research on the method for suppressing the difference in viscosity. As a result of this, they found that the viscosity change can be suppressed by adjusting a pH of the cation-modified silica raw material dispersion to less than pH 7.0 followed by storing the pH adjusted dispersion, and have accomplished the present invention.

That is, the problem is solved by a cation-modified silica raw material dispersion which is being stored after being adjusted to less than pH 7.0.

### Advantageous Effects of Invention

According to the present invention, a cation-modified silica dispersion wherein viscosity change with lapse of time is suppressed, can be provided, and also the variation in performance of a product using the dispersion as a raw material (for example, a polishing agent) can be suppressed.

### DESCRIPTION OF EMBODIMENTS

The present invention is described below. The present invention will not be limited only to the following embodiments. Additionally, in the present description, “X to Y” representing a range means “X or more and Y or less”. Additionally, unless otherwise specified, the operation and measurement of physical properties are measured at room temperature (20 to 25° C.)/relative humidity 40 to 50% RH.

(Cation-Modified Silica Raw Material Dispersion)

The present invention relates to a cation-modified silica raw material dispersion which is being stored after being adjusted to less than pH 7.0. According to a preferred embodiment of the present invention, the present invention relates to a cation-modified silica raw material dispersion which is being stored after being adjusted to less than pH 7.0, which is used for preparation of a polishing agent. When the present invention is considered from another viewpoint, cation-modified silica raw material dispersion of the present invention relates to a cation-modified silica raw material dispersion which has been adjusted to less than pH 7.0. Additionally, by adjusting a pH of the raw material dispersion to less than pH 7.0, a cation-modified silica dispersion in which the viscosity change with the lapse of time is suppressed can be provided and a variation in the performance of a product including the dispersion as a raw material (for example, a polishing agent) can be suppressed.

According to a preferred embodiment of the present invention, this cation-modified silica raw material dispersion means a dispersion of cation-modified silica to be used as a raw material of abrasive grains. According to a preferred embodiment of the present invention, this cation-modified silica raw material dispersion means a dispersion of cation-modified silica used as a raw material of a physicality improver and an inorganic binder in the fields of, for example, paint vehicles, binders, nanopowders, paper, fibers, and iron steel. The term “cation-modified” means that a cationic group (for example, an amino group or a quaternary cationic group) is bonded to the surface of silica particles.

(Silica)

The silica is preferably colloidal silica, from the viewpoint of preventing the occurrence of polishing flaws.

Colloidal silica may be produced by, for example, a sol-gel method. The colloidal silica produced by a sol-gel method is preferred because it contains less metal impurities and corrosive ions such as a chloride ion, which can be dispersed in semiconductors. The production of colloidal silica by a sol-gel method may follow a known method; specifically, a hydrolyzable silicon compound (for example, alkoxysilane or its derivative) is used as a raw material, and hydrolysis and condensation reactions are carried out, thereby obtaining colloidal silica. The silicon compound may be used one alone, or in combination of two or more of them.

(Cationic Modification)

According to the present invention, the silica is cation-modified. Additionally, according to a preferred embodiment of the present invention, the cationic modification is achieved by amino group modification. This embodiment further enhances the effect of the present invention.

In order to cation-modify silica, a silane coupling agent having a cationic group is added to silica, and the mixture is allowed to react at a predetermined temperature for a predetermined time.

The silane coupling agent used herein is not particularly limited, and examples include hydrochlorides of N-(β-aminoethyl)-γ-aminopropylmethyldimethoxysilane, N-(β-aminoethyl)-γ-aminopropyltrimethoxysilane, N-(β-aminoethyl)-γ-aminopropyltriethoxysilane, γ-aminopropyltriethoxysilane, γ-aminopropyltrimethoxysilane (β-aminopropyltrimethoxysilane), γ-triethoxysilyl-N-(α,γ-dimethyl-butylidene)propylamine, N-phenyl-γ-aminopropyltrimethoxysilane, and N-(vinylbenzyl)-β-aminoethyl-γ-aminopropyltriethoxysilan e, and octadecyldimethyl-(γ-trimethoxysilylpropyl)-ammonium chloride. Among them, N-(β-aminoethyl)-γ-aminopropyltrimethoxysilane, N-(β-aminoethyl)-γ-aminopropyltriethoxysilane, γ-aminopropyltriethoxysilane, and γ-aminopropyltrimethoxysilane are preferred, because they have good reactivity to colloidal silica. In the present invention, the silane coupling agent may be used alone, or in combination of two or more of them.

The silane coupling agent is preferably diluted with a hydrophilic organic solvent, and added to silica. Dilution with a hydrophilic organic solvent prevents the formation of agglomeration substance.

When a silane coupling agent is diluted with a hydrophilic organic solvent, 1 part by mass of a silane coupling agent is diluted with 5 to 50 parts by mass, preferably 10 to 20 parts by mass of a hydrophilic organic solvent.

The hydrophilic organic solvent is not particularly limited, and examples include lower alcohols such as methanol, ethanol, isopropanol, and butanol.

The usage of the silane coupling agent is not particularly limited, but about 0.01 to 3.0% by mass, preferably about 0.1 to 1.0% by mass with reference to silica.

The treatment temperature of cationic modification of silica with a silane coupling agent is not particularly limited, and may be from room temperature (for example, 25° C.) to about the boiling point of the dispersing medium for dispersing silica, and specifically from 0 to 100° C., preferably from room temperature (for example, 25° C.) to about 90° C. Additionally, the time is about 0.2 to 48 hours, preferably about 2 to 12 hours. This heat treatment is preferably carried out under reflux.

(Dispersion)

In the dispersion of the cation-modified silica obtained as described above, the average primary particle size, the average secondary primary particle diameter, the particle size distribution, and the content of the cation-modified silica may refer to known conditions as necessary.

Additionally, the dispersing medium used in the cation-modified silica raw material dispersion is not particularly limited, and may be an organic solvent or water. The water is preferably pure water or ultrapure water obtained by removing impurity ions with an ion exchange resin, and then removing foreign matter through a filter, or distilled water.

In the present invention, the cation-modified silica raw material dispersion to be stored after being adjusted to less than pH 7.0 may be a purchased commercial product.

(pH)

The cation-modified silica raw material dispersion of the present invention is stored after being adjusted to less than pH 7.0. In an embodiment of the present invention, the pH of the cation-modified silica raw material dispersion during storage is not particularly limited as long as it is less than 7.0, and preferably 6.0 or less, more preferably 5.0 or less, and even more preferably 4.0 or less, from the viewpoint of efficiently achieving the effect of viscosity change suppression.

As described above, according to a preferred embodiment of the present invention, the pH is adjusted to 4.0 or less. According to this embodiment, the effect of suppressing the viscosity change can be more efficiently achieved. Although the lower limit of the pH is not particularly limited, it is preferably 1.0 or more or, 1.1 or more, and also preferably more than 2.0, from the viewpoints of corrosion of the container and safety of storage. The pH value in the present invention refers to the value measured under the conditions described in Example.

In order to adjust the pH of the cation-modified silica raw material dispersion of the present invention, a pH adjusting agent is used.

The pH adjusting agent may be an inorganic compound or an organic compound, and specific examples include inorganic acids such as sulfuric acid, nitric acid, dimethyl sulfate, boric acid, carbonate, hypophosphorous acid, phosphoric acid, and phosphoric acid; organic acids such as carboxylic acids such as citric acid, formic acid, acetic acid, propionic acid, benzoic acid, salicylic acid, glyceric acid, oxalic acid, malonic acid, succinic acid, maleic acid, phthalic acid, malic acid, tartaric acid, 2-hydroxy isobutyric acid, 3-hydroxy isobutyric acid, and lactic acid; and organic sulfuric acids such as methane sulfonic acid, ethane sulfonic acid, and isethionic acid. Additionally, when the above-described acid is a divalent or higher multivalent acid (for example, sulfuric acid, carbonate, phosphoric acid, or oxalic acid), it may be a salt as long as it can release one or more protons (H⁺). Specific examples include ammonium hydrogencarbonate and ammonium hydrogen phosphate (the kind of the counter cation may be basically any one, but a weak base cation (for example, ammonium or triethanolamine) is preferred). In particular, when used in a polishing agent, sulfuric acid, nitric acid, dimethyl sulfate, and phosphoric acid are preferred because they will not promote dissolution of the surface to be polished, and nitric acid and phosphoric acid are more preferred from the viewpoint of corrosion of the surface to be polished. When the pH is adjusted to less than 7.0, as necessary, a basic pH adjusting agent (for example, ammonia) may be added.

(Storage and Storage Method)

The cation-modified silica raw material dispersion of the present invention is stored after being adjusted to less than pH 7.0. According to a preferred embodiment of the present invention, storage of the cation-modified silica raw material dispersion means the condition from the point when the dispersion is allowed to stand (including transportation) without operation such as stirring to the point when the dispersion is used for manufacturing of a product (for example, a polishing agent).

It is noted that in the present invention, the concept that “stored after being adjusted to less than pH 7.0” does not include the condition wherein the cation-modified silica raw material dispersion is adjusted to less than pH 7.0 for the purpose of measuring its physical properties. The reason for this is that the cation-modified silica raw material dispersion adjusted to less than pH 7.0 for measuring physical properties is not used for the preparation of a polishing agent, but is merely a sample subjected to the measurement of physical properties.

In the present invention, usually, the commencement of storage is the start of standing without operation such as stirring after the preparation of the cation-modified silica raw material dispersion, and the expiration of storage is, according to a preferred embodiment of the present invention, the point when the dispersion is subjected to manufacturing (preparation) of a product (for example, a polishing agent).

As the storage conditions, the environment is preferably at normal pressure (atmospheric pressure). The temperature is preferably from 5 to 80° C., more preferably from 15 to 50° C., and even more preferably from 20 to 43° C. The relative humidity is preferably from 15 to 70% RH, more preferably from 20 to 55% RH, and even more preferably from 25 to 45% RH.

The storage duration is, although not particularly limited, for example, about one hour to 360 days, about one day to 180 days, about two days to 30 days, or about three days to seven days.

In the present invention, the cation-modified silica raw material dispersion is preferably adjusted to less than pH 7.0 immediately after preparation, but may be not adjusted to less than pH 7.0 over the whole period from the commencement to expiration of storage. According to a preferred embodiment of the present invention, the concept that “stored after being adjusted to less than pH 7.0” includes, for example, providing a cation-modified silica raw material dispersion whose pH has been adjusted to a weak alkaline region (usually, about pH 8.0 to 9.0, or, about pH 8.0 to 10.0) (for example, by purchase of a commercial product), immediately followed by adjusting it to less than pH 7.0, and allowing it to stand until it is subjected to manufacturing (preparation) of a product (for example, a polishing agent).

However, the viscosity of the cation-modified silica raw material dispersion likely changes with time, so that the dispersion is preferably adjusted to less than pH 7.0 as soon as possible.

Therefore, the present invention provides a method for storing a cation-modified silica raw material dispersion, comprising adjusting a pH of the cation-modified silica raw material dispersion to less than pH 7.0 followed by storing the pH adjusted dispersion.

(Method for Producing Polishing Agent)

The present invention provides a method for producing a polishing agent, comprising a preparation step for preparing the above described cation-modified silica raw material dispersion as a raw material of the polishing agent.

Although the method for producing a polishing agent is not particularly limited, as described above, it can be obtained by preparing a cation-modified silica raw material dispersion, which has been stored after being adjusted to less than pH 7.0, as a raw material of the polishing agent, and mixing it with cation-modified silica and other components as necessary by stirring in a dispersing medium.

The dispersing medium is preferably selected from the above-described ones. According to a preferred embodiment of the present invention, the polishing agent may contain the components other than those derived from the raw material used for the synthesis of cation-modified silica and the pH adjusting agent used for adjusting the pH to less than 7.0. Accordingly, the present invention provides a product containing the components other than the components derived from the raw material used for synthesis of the cation-modified silica and the pH adjusting agent used for adjusting the pH to less than 7.0 (for example, a polishing agent).

The other components depend on the polishing use and are not particularly limited, and examples include components such as a pH adjusting agent, an oxidant, a reducing agent, a surfactant, a water-soluble polymer, and an antifungal agent. However, usually, a pH of the polishing agent would be adjusted to a different pH of the cation-modified silica raw material dispersion by adding a pH adjusting agent to the cation-modified silica raw material dispersion. Additionally, for example, when a material containing tungsten is polished as the below-described object to be polished, the polishing agent can be prepared by mixing the cation-modified silica raw material dispersion, an oxidant, and an anticorrosive.

Although the temperature during mixing the components is not particularly limited, it is preferably from 10 to 40° C., and the temperature maybe increased for increasing the rate of dissolution. Additionally, the mixing time is also not particularly limited.

According to a preferred embodiment of the present invention, the above-described provision step preferably includes a confirmation step for confirming the rate of change of the viscosity of the cation-modified silica raw material dispersion. By carrying out this step, it can be confirmed that the cation-modified silica raw material dispersion allows suppression of variation in performance, whereby greater reliability is given to users.

The rate of change is the rate of viscosity change at any two points during the above-described storage period, and refers to the value obtained by dividing the value of the relatively higher viscosity by the value of the relatively lower viscosity (for example, when the both values are the same, the rate of change is 1.00).

For example, the rate of change can be calculated as follows: after purchasing a commercial product of a cation-modified silica raw material dispersion (pH: the above-described weak alkaline region), preferably without delay, the dispersion is adjusted to less than pH 7.0 and the viscosity is measured, and the viscosity is measured again before, preferably immediately before, the dispersion is used as a raw material of a polishing agent, and the value of the relatively higher viscosity is divided by the value of the relatively lower viscosity so that rate of change can be obtained.

In a preferred embodiment of the present invention, in the above-described confirmation step, the fact that the rate of change is being preferably 1.10 or less, more preferably 1.08 or less, and even more preferably 1.06 or less is confirmed. Although the lower limit is not particularly limited, it is “1.00” when the both values are equal in the case where the technical effect of the present invention is thoroughly achieved. Thus, variation in the polishing performance can be significantly reduced by subjecting the cation-modified silica raw material dispersion after the confirmation step and storage to the preparation of a polishing agent.

(Polishing Step, Method for Producing Substrate)

The present invention provides a polishing method including obtaining a polishing agent by the above-described method for producing a polishing agent, and polishing the object to be polished using it. Additionally, the present invention also provides a method for producing a substrate, including the polishing method. A substrate having stable performance is provided by polishing a substrate which has not been polished yet using the polishing method of the present invention.

(Object to be Polished)

The object to be polished is not particularly limited, and examples include silicon-containing materials and various metal materials.

Examples of the silicon-containing material include the objects to be polished having a silicon-oxygen bond such as a silicon oxide membrane, black diamond (BD: SiOCH), fluorosilicate glass (FSG), hydrogen silsesquioxane (HSQ), CYCLOTENE (benzocyclobutene resin), SiLK (hydrogenated silsesquioxane), and methylsilsesquioxane (MSQ); objects to be polished having a silicon-nitrogen bond such as a silicon nitride membrane, silicon carbide nitride (SiCN); and objects to be polished having a silicon-silicon bond such as polysilicon, amorphous silicon, single crystal silicon, n-type doped single crystal silicon, and p-type doped single crystal silicon, and examples of the various metal materials include copper, aluminum, hafnium, cobalt, nickel, titanium, and tungsten.

The polishing apparatus may be a common polishing apparatus equipped with a holder for holding a substrate and others having an object to be polished, and a motor whose rotation speed can be changed, and has a polishing table to which a polishing pad (polishing cloth) can be attached.

The polishing pad may be selected from, for example, a common nonwoven fabric, polyurethane, and porous fluorocarbon resins without particular limitation. The polishing pad is preferably grooved for retaining the polishing agent.

The polishing conditions are not particularly limited; for example, the rotation speed of the polishing table is preferably from 10 to 500 rpm, the carrier rotation speed is preferably from 10 to 500 rpm, the pressure applied to the substrate having the object to be polished (polishing pressure) is preferably from 0.1 to 10 psi. The method for feeding the polishing agent to the polishing pad is also not particularly limited; for example, the polishing agent is continuously fed with a pump. Although the feeding amount is not limited, the surface of the polishing pad is preferably always covered by the polishing agent of the present invention.

(Method for Suppressing Viscosity Change)

In the present invention, the cation-modified silica raw material dispersion is being stored after being adjusted to less than pH 7.0, whereby the viscosity change is suppressed.

Accordingly, the present invention provides a method for suppressing viscosity change of a cation-modified silica raw material dispersion, comprising adjusting a pH of the cation-modified silica raw material dispersion to less than pH 7.0 followed by storing the pH adjusted dispersion.

In this method for suppressing the viscosity change, the explanations of storage, pH, and others are omitted herein, because the above-described ones can be applied.

### EXAMPLES

The present invention is further described with reference to the following examples and comparative examples. However, the technical scope of the present invention will not be limited only to the following examples. Additionally, in the following examples, unless otherwise specified, the operation was carried out at room temperature (25° C.)/relative humidity 40 to 50% RH.

1. Test Sample

A commercial dispersion of amino group-modified silica (pH=9.28) (dispersing medium: water) (hereinafter referred to as commercial dispersion), and phosphoric acid (Kanto Chemical Co., Inc., special grade, 95%) as a pH adjusting agent were provided.

The pH measurement was carried out using a benchtop pH meter (LAQUAF-73, manufactured by Horiba Ltd.) equipped with a glass electrode type hydrogen ion concentration indicator (DS-70, manufactured by Horiba Ltd.) (liquid temperature: 25° C.)

The commercial dispersion was obtained by dropping a mixture of methanol and 3-aminopropyl trimethoxysilane to a dispersion of colloidal silica, and then removing the methanol by reflux.

2. Preparation Method

1000 mL of the commercial dispersion was collected, and the pH was adjusted to pH 1.22 (Example), pH 1.98 (Example), pH 3.75 (Example), and pH 7.64 (Comparative Example) using phosphoric acid under stirring with a magnetic stirrer, thereby providing four samples.

3. Storage (High Temperature Storage)

300 mL portions of the four samples prepared in the above-described Item 2. and a commercial dispersion (pH=9.28) without addition of phosphoric acid were collected and added in polypropylene containers (number of samples: five), and stored in a thermostat drier (DK-600, Yamato Scientific Co., Ltd.) set at 60° C. and 80° C. for seven days. The storage at 60° C. and 80° C. is acceleration test, and correspond to storage for about 80 days and about 300 days at normal temperature (25° C.), respectively.

4. Viscosity Measurement

The viscosity was measured using a viscometer (Cannon-Fenske, Shibata Scientific Technology Ltd.), and calculated according to the following formula (the viscosity was measured at 25° C.).

Viscosity=specific gravity×efflux time (second)

The value of the viscosity at “25° C., Day 0” in Table 1 was measured immediately after preparing the above-described five samples (measuring 300 mL portions of them in polypropylene containers); the value of the viscosity at “60° C., Day 7” in Table 1 was obtained by storing the samples at 60° C. for seven days, standing them in an environment at 25° C., and measuring their viscosity at 25° C.; the value of the viscosity at “80° C., Day 7” in Table 1 was obtained by storing the samples at 80° C. for seven days, standing them in an environment at 25° C., and measuring their viscosity at 25° C.

The result is given in Table 1.

TABLE 1

| | 25° C. Day 0 | 60° C. Day 7 | 80° C. Day 7 |
|---|---|---|---|
| | Viscosity | Viscosity | Viscosity |
| | (mPa*sec) | (mPa*sec) | (mPa*sec) |
| Example | 1.41 | 1.44 | 1.45 |
| (pH = 1.22) | | | |
| Example | 1.41 | 1.45 | 1.44 |
| (pH = 1.98) | | | |
| Example | 1.42 | 1.43 | 1.43 |
| (pH = 3.75) | | | |
| Example | 1.44 | 1.61 | 1.73 |
| (pH = 7.64) | | | |
| Example | 7.48 | 5.30 | 3.33 |
| (pH = 9.28) | | | |

* The viscosity was 1.123 for all the examples and comparative examples.

<Discussion>

As indicated in Table 1, the cation-modified silica raw material dispersion of Example is being stored after being adjusted to less than pH 7.0, so that the viscosity change has been suppressed. Accordingly, it is suggested that such the cation-modified silica raw material dispersion is used to manufacture (prepare) a product (for example, a polishing agent) so that an influence on polishing performance can be significantly reduced.

On the other hand, the cation-modified silica raw material dispersion of Comparative Example stored at a pH of 7.0 or more caused viscosity change with the lapse of time. Accordingly, it is suggested that such the cation-modified silica raw material dispersion is used to manufacture (prepare) a product (for example, a polishing agent) so that a polishing performance would be influenced.

This application is based on Japanese Patent Application No. 2016-067149 filed on Mar. 30, 2016, the disclosure of which is incorporated as a whole by reference herein.

1. A cation-modified silica raw material dispersion which is being stored after being adjusted to less than pH 7.0.

2. The cation-modified silica raw material dispersion according to claim 1, wherein the cation-modified silica raw material dispersion is being stored after being adjusted to less than pH 4.0.

3. The cation-modified silica raw material dispersion according to claim 1, wherein the cationic modification is achieved by amino group modification.

4. A method for producing a polishing agent, comprising a preparation step for preparing the cation-modified silica raw material dispersion according to claim 1 as a raw material of the polishing agent.

5. The method according to claim 4, wherein the preparation step comprises a confirmation step for confirming viscosity change rate of the cation-modified silica raw material dispersion.

6. A method for storing a cation-modified silica raw material dispersion, comprising:
adjusting a pH of the cation-modified silica raw material dispersion to less than pH 7.0 followed by storing the pH adjusted dispersion.

7. A method for suppressing viscosity change of a cation-modified silica raw material dispersion, comprising:
adjusting a pH of the cation-modified silica raw material dispersion to less than pH 7.0 followed by storing the pH adjusted dispersion.

8. A polishing method comprising:
obtaining a polishing agent by the method according to claim 4; and
polishing an object to be polished using the polishing agent.

9. A method for producing a substrate, comprising the polishing method according to claim 8.
